(19) United States
(12) Patent Application Publication
(10) Pub. No.: US 2007/0143316 A1
(43) Pub. Date: Jun. 21, 2007

(54) Universal plug and play virtual directory service system and method thereof

(75) Inventors: Po-Hsu Chen, Taipei (TW); Jeou-Ing Ying, Taipei (TW)

Correspondence Address: BIRCH STEWART KOLASCH & BIRCH, PO BOX 747, FALLS CHURCH, VA, 22040-0747, US

(73) Assignee: Wistron Corp.

(21) Appl. No.: 11/352,327

(22) Filed: Feb. 13, 2006

(30) Foreign Application Priority Data
Dec. 20, 2005 (TW) 94145352

(51) Int. Cl. G06F 7/00

(52) U.S. Cl. 707/100

(57) ABSTRACT

A UPNP virtual directory service system is disclosed, which includes: a UPnP internet; a UPNP storage device which is electrically coupled to the UPNP internet, and outputs a usable signal; and a control point which is electrically coupled to the UPnP internet, and comprises a virtual storage device, wherein the virtual storage device receives the usable signal, accesses a service-data directory service-data directory to the UPnP storage device, and stores and simulates in the virtual storage device. Therefore, a user can use audio/video play device that is built-in a person computer to play the audio/video data on the UPnP storage device.

### BACKGROUND OF THE INVENTION

(1) Field of the Invention

The invention relates to a virtual directory service, and more particularly, to a universal plug and play virtual directory service system and method thereof.

(2) Description of the Prior Art

At digitalized homes, control point can use a specific technology, such as universal plug and play (UPnP) which is connected to a content source, such as media server, for getting a content directory service. The control point can select a specific content item and assign a specific device, such as a media renderer, so as to play.

The construction is used as a standard for home appliances' mutual operations at the digitalized homes, which defines a manner that peer-to-peer devices are connected through the internet and communicate with one another, wherein these devices can be artificial intelligent equipments, wireless devices, personal computers and other devices having communication functions. The device in the UPnP construction can be a control device (CD) and control point (CP). Any devices can be both the control device and/or control point at the same time.

In the UPnP construction, devices includes internet operations of addressing, discovery, description, control, events and presentation, the details of which can be seen in definitions of the UPnP, and thus, are disregarded here. When a UPnP control device is connected to the internet, it can send messages through the internet, so as to show that it can provide a client with services. Other devices, such as the control point, in the internet can be used to a controller to receive information on usability of related devices, or search through the internet so as to position the UPNP devices. Once the control point finds a device regardless of through receiving the information or through its search, it can get the detailed descriptions regarding the device and service thereof. The control point can also search for the service that can represent the device. And then the control point can use these descriptions and related services to send requests to the device to use the device. The control device makes a response to the requests from the control point, executes, and then makes a response to the control point, as so to provide the information on related devices' status.

Although the UPnP has defined the control point the media server and play device of electronic products, in a file system of the media server, the UPnP is asked to have a steaming function so as to make the play device play. However, to the UPnP, the directory of the media server has not been totally controlled and managed yet; moreover, the UPNP is not compatible with the present personal computers, and needs a specific media server to make the UPNP server be operated.

### SUMMARY OF THE INVENTION

It is an object of the present invention to provide a universal plug and play virtual directory service system and method thereof to integrate the present personal computers and the UPnP construction; so that an audio/video play device that is built-in the personal computers can play audio/video data stored in the UPnP storage device.

In order to achieve aforesaid object, the UPNP virtual directory service system of the present invention includes a UPnP internet, a UPnP storage device and a point. The UPNP storage device is electrically coupled to the UPnP internet, and outputs a usable signal. The control point is electrically coupled to the UPNP internet, and includes a virtual storage device. The virtual storage device is used to receive the usable signal, and accesses a service-data directory to the UPnP storage device, so as to store and simulate in the virtual storage device.

The UPNP virtual directory service method of the present invention is applied to a control point. The UPnP virtual directory service method includes the steps of: the control point receiving a usable signal and getting a service-data directory according to the usable signal; the control point establishing indexes and attributes of a plurality of data, and getting a cache index that is correspondent to the service-data directory.

According a preferred embodiment of the present invention, when the control point receives a search command, the search command the cache index is used to search for the data to be searched. Next, when the data are searched, the positions and attributes of the data are displayed.

### BRIEF DESCRIPTION OF THE DRAWINGS

The present invention will now be specified with reference to its preferred embodiment illustrated in the drawings, in which:

FIG. 1 is a system block diagram of UPnP virtual directory service system of the present invention.

FIG. 2 is a system block diagram of Shell namespace directory service module and cache index directory service module of the present invention.

FIG. 3 is a flowchart of the UPnP virtual directory service method of the present invention.

### DESCRIPTION OF THE PREFERRED EMBODIMENTS

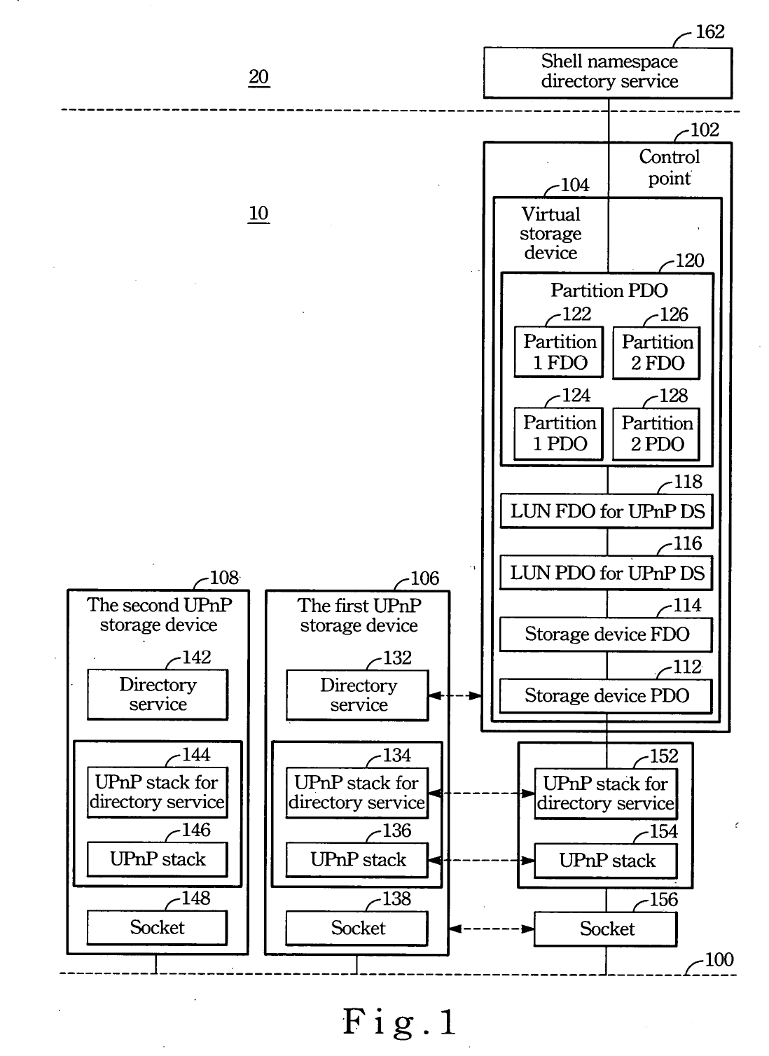

Please refer to FIG. 1 which shows a system block diagram of the UPnP virtual directory service system of the present invention. In FIG. 1, the UPnP virtual directory service system 10 includes a UPnP internet 100, a control point 102, a first UPnP storage device 106, and a second UPnP storage device 108. In the preferred embodiment, the two upnP storage device 106 and 108 are taken for example, but are not limited.

In the preferred embodiment, the first UPNP storage device 106 and the second uPnP storage device 108 are electrically coupled to the UPnP internet 100 and respectively output a signal to the control point 102 after being connected to the UPnP internet 100.

The first UPnP storage device 106 includes a directory service 132, a UPnP directory service stack 134, a UPnP stack 136 and a socket 138. Similarly, the second UPnP storage device 108 includes a directory service 142, a UPNP directory service stack 144, a UPNP stack 146 and a socket 148. The first UPnP storage device 106 and the second UPnP storage device 108 are electrically connected to the UPnP internet 100 through respectively using the socket 138 and socket 148.

In the preferred embodiment, the UPnP stack 134 and 144 for the directory service and the UPnP stack 136 and 146 are defined by Microsoft Corp., and are omitted here.

The control point 102 includes a virtual storage device 104, a UPnP directory service stack 152 a UPnP stack 154 and socket 156. The control point is electrically connected to the UPnP internet 100 through the connector 156.

The virtual storage device 104 includes a storage device physical device object 112 (PDO), a storage device function device object 114 (FDO), a logic unit for the UPnP directory service (LUN PDO for UPNP DS) 116, a LUN FDO for UPnP DS 118, and a partition PDO 120. The storage device PDO 112, the storage device FDO 114, the LUN PDO for UPNP DS 116, and the LUN FDO for UPnP DS 118 have been defined by Microsoft Corp., and thus are omitted here.

In the preferred embodiment of the present invention, the partition PDO 120 includes a partition 1 FDO 122, a partition 1 PDO 124, a partition 2 FDO 126, a partition 2 PDO 128. The partition 1 FDO 122 and the partition 2 FDO 126 are used to respectively simulate the service-data directory of the first UPNP storage device1 106 and the second upnP storage device 108. The partition 1 PDO 124 and the partition 2 PDO 128 are respectively used to access to the first UPnP storage device 106 and the second UPnP storage device 108 according to the service-data directory.

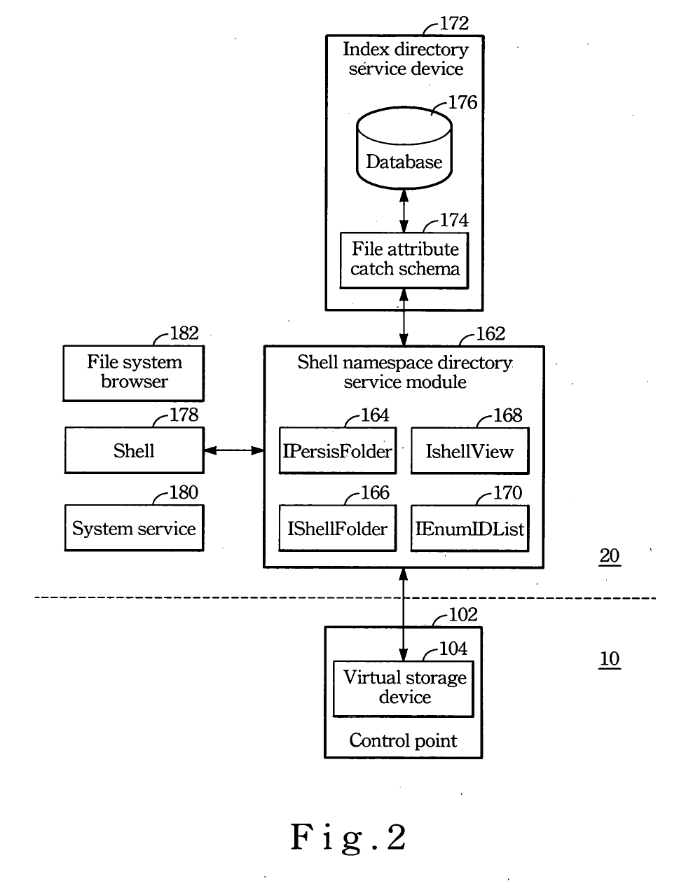

Please refer to FIGS. 1 and 2. FIG. 2 is a construction view of shell namespace directory service module and index directory service.

In the preferred embodiment of the present invention, in FIG. 2, The Shell unit 20 includes a shell namespace directory service module 162 and index directory service device 172. The shell namespace directory service 162 is connected to the virtual storage device 104 and the index directory service device 172.

The shell namespace directory service module 162 includes IPersisFolder 164, IShellFolder 166, IshellView 168 and IEnumIDList 170, which have been defined by Microsoft Corp., and thus are omitted here.

The index directory service device 172 includes a file attribute cache schema 172 and a database 176. The database 176 stores a cache index that is correspondent to the service-data directory. The file attribute catch schema 174 is connected to the database 176 for providing file attribute according to the cache index.

The shell unit 20 further includes a system service 180 and a file system browser 182.

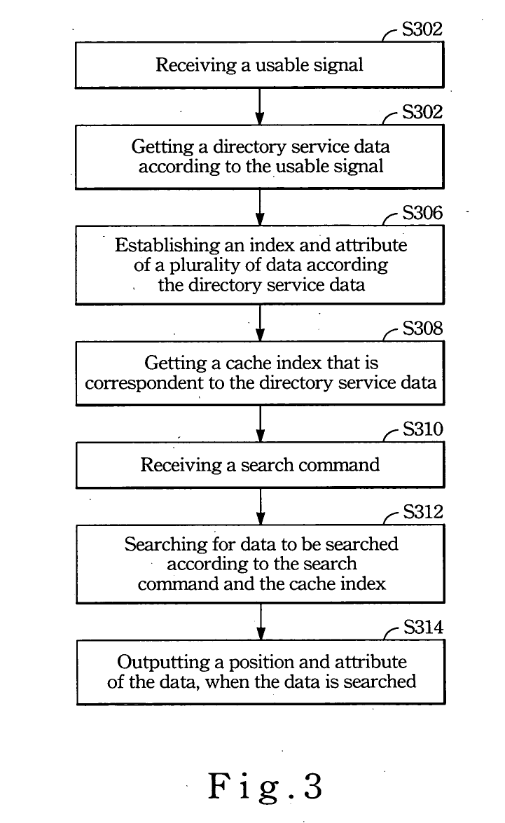

Please refer to FIG. 3 which is a flowchart of the steps of a method for UPnP virtual directory service. In the preferred embodiment, the method for UPnP virtual directory service UPnP virtual service system 10 includes that after the first UPnP storage device 106 or the second UPnP storage device 108 is connected to the UPnP internet 100, the first UPnP storage device 106 or the second UPnP storage device 108 sends a usable signal to the virtual storage device 104 through the UPnP internet 100, to inform the virtual storage device 104 that the first UPnP storage device 106 or the second UPnP storage device 108 is in a usable status (s302).

The virtual storage device 104 accesses the service-data directory to the first UPnP storage device 106 or the second UPnP storage device 108, or sends a signal that requests the first UPnP storage device 106 or the second UPnP storage device 108 to send the service-data directory, so as to get the service-data directory 132 and 142 (s304).

The index and attribute of the first UPnP storage device 106 or the second upnP storage device 108 are established according to the service-data directory (s306), and a cache index that is correspondent to the service-data directory is stored in the database 176 (s308).

There is provided with the virtual service-data directory in the virtual storage device 104, wherein the virtual directory service is stored in the first UPnP storage device 106 and the second UPNP storage device 108. That is, use does not have to look up the service-data directory through the first UPnP storage device 106 and the second UPNP storage device 108, but is able to see, at the control point 102, the file data of the storage devices that are connected to the UPNP internet 100, and can play and access to the data through using the control point 102.

When the user gives a search command through using the control point 102 (s310), the shell unit 20 makes the search according to the cache index in the database 176 and the search command. When the index of the data is searched, the position and attribute of the data is outputted, so that the user can play and access to the data (s314).

In the preferred embodiment of the present invention, the control point 102 can be a personal computer, notebook computer or other computer products.

Summing up the above-mentioned, the UPnP virtual directory service system and method thereof can integrate personal computers and the UPNP construction, so that the audio/video play device that is built-in a computer can play the audio/video data that is stored in the UPnP storage device

While the present invention has been particularly shown and described with reference to a preferred embodiment, it will be understood by those skilled in the art that various changes in form and detail may be without departing from the spirit and scope of the present invention.

I claim:

1. A UPnP virtual directory service system, comprising:
a UPNP internet;
a UPNP storage device which is electrically coupled to the UPnP internet, and outputs a signal; and
a control point which is electrically coupled to the UPNP internet, and further comprises a virtual storage device, wherein the virtual storage device receives the signal from the UPNP storage device, accesses a service-data directory to the UPnP storage device, and stores and simulates in the virtual storage device.

2. The system according to claim 1, wherein the control point accesses a plurality of data of the UPnP storage device according to the service-data directory.

3. The system according to claim 2, wherein when the virtual storage device receives the service-data directory, then an index and attribute of the plurality of data are established according to the service-data directory.

4. The system according to claim 1, wherein the virtual storage device comprises a partition PDO for storing the service-data directory and simulating the UPnP storage device.

5. The system according to claim 4, wherein the partition PDO comprises at least one partition FDO for simulating the service-data directory of the UPnP storage device.

6. The system according to claim 5, wherein the partition PDO includes at least one partition PDO, and accesses to the UPnP storage device according to the service-data directory.

7. The system according to claim 8, wherein the partition PDO is stacked on the partition FDO.

8. The system according to claim 1, wherein the control point further comprises a shell unit, the shell unit being connected to the virtual storage device and comprising:
a shell namespace directory service module which is connected to the virtual storage device for displaying the service-data directory; and
an index directory service module which is connected to the shell namespace directory service module for providing an index service.

9. The system according to claim 8, wherein the index directory service module comprises:
a database which stores a cache index that is correspondent to the service-data directory; and
a file attribute cache construction which is connected to the database for providing an file attribute according to the cache index.

10. The system according to claim 9, wherein when the control point receives a search command, the search command and the cache index are used to search for the data to be searched.

11. The system according to claim 10, wherein when the data are searched, the positions and attributes of the data are displayed.

12. A method for UPnP virtual directory service, which is applied to a control point, the method comprising the steps of:
establishing electrical connection of a UPNP storage device and a control point via a UPNP internet;
accessing and obtaining a service-data directory of the UPnP storage device from a virtual storage device via the UPnP internet;
establishing an index and attribute of a plurality of data according to the service-data directory; and
getting a cache index that is correspondent to the service-data directory.

13. The method according to claim 12, further comprising the steps of:
receiving a search command;
searching for data to be searched according to the search command and the cache index; and
outputting a position and attribute of the data, when the data is searched.
